(19) United States
(12) Patent Application Publication
(10) Pub. No.: US 2024/0362677 A1
(43) Pub. Date: Oct. 31, 2024

(54) INFORMATION PROCESSING DEVICE, INFORMATION PROCESSING METHOD, AND PROGRAM THEREFOR

(71) Applicant: Rakuten Group, Inc., Tokyo (JP)

(72) Inventor: Asako KUDO, Tokyo (JP)

(73) Assignee: Rakuten Group, Inc., Tokyo (JP)

(21) Appl. No.: 18/647,082

(22) Filed: Apr. 26, 2024

(30) Foreign Application Priority Data
Apr. 28, 2023 (JP) 2023-074085

(51) Int. Cl. G06Q 30/0251

(52) U.S. Cl. CPC G06Q 30/0255

(57) ABSTRACT

The purpose of the present disclosure is to enable more accurate measurement of the advertising effectiveness. Provided is an information processing device having: a first receiver that receives first identification information for identifying a container used by a user, from a display device that displays an advertisement about a product; a second receiver that receives, from a terminal, second identification information for identifying a container used by a user who purchased a product and product information about the product; and a determination section that determines that the user who used the container purchased the product after viewing the advertisement, when the first identification information received from the display device matches the second identification information received from the terminal and further the product information received from the terminal corresponds to the advertisement displayed on the display device.

### CROSS-REFERENCE TO RELATED APPLICATION

The present application is based upon Japanese Patent Application No. 2023-074085, filed on Apr. 28, 2023, the disclosure of which is incorporated herein by reference.

### BACKGROUND

### Field

The present disclosure relates to an information processing device, an information processing method, and program therefor.

### Description of Related Art

Currently, a display device called “digital signage” is already known. For example, Japanese Unexamined Patent Application Publication No. 2021-176061 discloses that the advertising content displayed on a digital signage is able to be switched by taking into account the behavior of a customer until he/she comes in front of the digital signage. Japanese Unexamined Patent Application Publication No. 2021-176061 also discloses that, by using images taken by cameras provided on a plurality of digital signages, it is possible to track customer behaviors, such as customer contact with products after viewing the advertising content displayed on a digital signage and whether the customers purchased the products that the customers came in contact with.

The advertising effectiveness is able to be measured by determining whether a user who has referred to the advertisement displayed on the digital signage has actually purchased the advertised product. In the technique described in Japanese Unexamined Patent Application Publication No. 2021-176061, however, in the case where a user's face is not captured in the image of the camera provided in the digital signage installed in front of the POS register, or in the case where the product purchased by the user is not captured in the image, the user or the product purchased is not able to be correctly recognized, and the advertising effectiveness is problematically not able to be measured correctly.

### SUMMARY

Therefore, an object of the present disclosure is to provide a technique that enables more accurate measurement of the advertising effectiveness.

According to an aspect of the present disclosure, there is provided an information processing device including: a first receiver that receives first identification information for identifying a container used by a user from a display device that displays an advertisement about a product; a second receiver that receives, from a terminal, second identification information for identifying a container used by a user who purchased a product and product information about the product; and a determination section that determines that the user who used the container purchased the product after viewing the advertisement, when the first identification information received from the display device matches the second identification information received from the terminal and further the product information received from the terminal corresponds to the advertisement displayed on the display device.

The present disclosure enables provision of a technique that enables more accurate measurement of the advertising effectiveness.

### BRIEF DESCRIPTION OF DRAWINGS

FIG. 1 is a diagram illustrating an example of an advertising system configuration.

FIG. 2 is a diagram illustrating an example of a hardware configuration of an information processing device.

FIG. 3 is a diagram illustrating an example of hardware configurations of a digital signage and a POS terminal.

FIG. 4 is a diagram illustrating examples of functional block configurations of an information processing device, a digital signage, and a POS terminal.

FIG. 5 is a diagram illustrating examples of an advertising DB and an advertising management DB.

FIG. 6 is a sequence diagram illustrating an example of a processing procedure performed by the advertising system.

FIG. 7 is a sequence diagram illustrating an example of a processing procedure performed by the advertising system.

### DETAILED DESCRIPTION

With reference to the accompanying drawings, embodiments of the present disclosure are described. In the drawings, those with the same symbols have the same or similar configurations.

### <System Configuration>

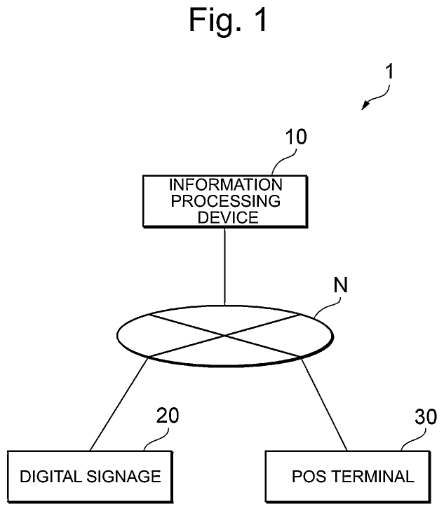

FIG. 1 is a diagram illustrating an example of a system configuration of an advertising system 1. The information processing device 10 is connected to one or more digital signages 20 (also referred to as display devices) and one or more POS (point of sales) terminals 30 (also referred to as terminals) via a wireless or wired communication network N, and so that they are able to mutually communicate with each other.

The information processing device 10 is a device that measures the advertising effectiveness displayed on the digital signage 20. The information processing device 10 determines whether the user who viewed the advertisement displayed on the digital signage 20 actually purchased the product or not, on the basis of information acquired from the digital signage 20 and the POS terminal 30. In addition, the information processing device 10 previously stores data related to the attributes of the users who purchased the product after viewing the advertisement, and outputs statistical data indicating the types of users who purchased the product after viewing the advertisement.

The digital signage 20 has a display and shows an advertisement about the product on the display. The advertisement data (still image data or video data) for displaying the advertisement may be delivered to the digital signage 20 from the information processing device 10 or from another device other than the information processing device 10. The digital signage 20 is equipped with a tag reader, which is able to read the tag ID (hereinafter, referred to as “container ID”) of a tag attached to the container. The container is not limited to a basket, but also includes a shopping cart, a shopping bag, and so on. The tag may be, for example, an RF tag corresponding to a radio frequency identification (RFID). The container ID is an identifier that uniquely recognizes a container used in a store.

In addition, the digital signage 20 is equipped with a photography device (camera), which is able to take pictures of users viewing the display of the digital signage 20. In this embodiment, it is assumed that the digital signage 20 is installed in the same store as the POS terminal 30, but it is not necessarily limited thereto.

The POS terminal 30 is installed in a store and performs various accounting processes. Like the digital signage 20, the POS terminal 30 is able to read the container ID. The POS terminal 30 may also be equipped with a photography device (camera) to take a picture of a user who is paying the bill.

In this embodiment, the digital signage 20 reads the container ID of the container used by the user and sends the container ID to the information processing device 10. In addition, the POS terminal 30 reads the container ID of the container used by the user at the time of accounting and transmits the container ID to the information processing device 10 with the information about the purchased product. When the container ID of the container of the user who purchased the product matches the container ID acquired from the digital signage 20 and further the product purchased by the user is the product related to the advertisement displayed on the digital signage 20, the information processing device 10 determines that the user using the container has viewed the advertisement displayed on the digital signage 20 and then purchased the product.

### <Hardware Configuration>

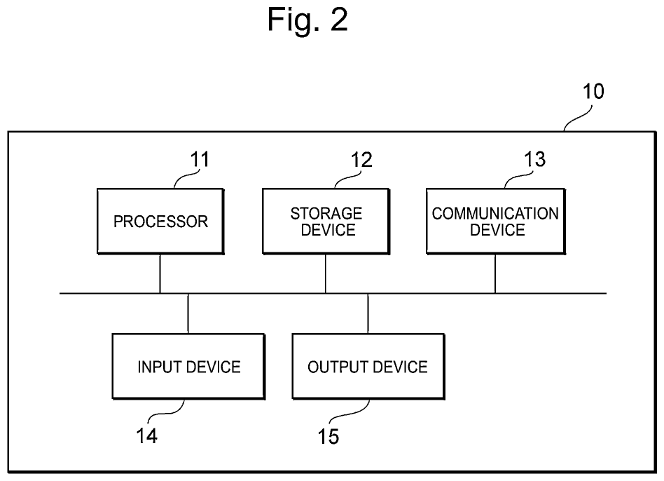

FIG. 2 is a diagram illustrating an example of a hardware configuration of the information processing device 10. The information processing device 10 has a processor 11 such as a central processing unit (CPU) and a graphical processing unit (GPU), a storage device 12 such as a memory (for example, a random access memory [RAM] or a read only memory [ROM]), a hard disk drive (HDD), and/or a solid state drive (SSD), a communication device 13 for wired or wireless communication, and an input device 14 that receives input operations, and an output device 15 that outputs information. The input device 14 is, for example, a keyboard, a touch panel, a mouse, and/or a microphone or the like. The output device 15 is, for example, a display, a touch panel, and/or a speaker or the like. The information processing device 10 may be formed of one or more physical servers, and so on, or may be formed of a virtual server running on a hypervisor, or may be formed of a cloud server.

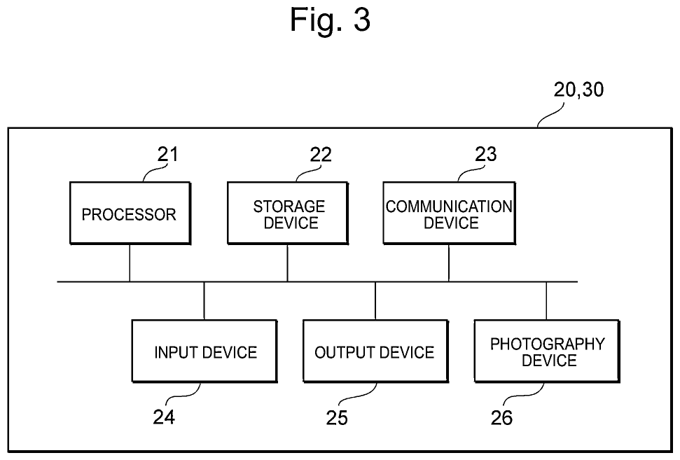

FIG. 3 is a diagram illustrating an example of hardware configurations of the digital signage 20 and the POS terminal 30. The digital signage 20 and the POS terminal 30 each have a processor 21 such as a CPU, a GPU, or the like, a memory (for example, a RAM or a ROM), a storage device 22 such as an HDD and/or an SSD, a communication device 23 for wired or wireless communication, an input device 24 that receives input operations, and an output device 25 that outputs information, and a photography device 26. The communication device 23 may be capable of communicating with an RFID. The input device 24 is, for example, a keyboard, a touch panel, a mouse, and/or a microphone or the like. The output device 25 is, for example, a display, a touch panel, and/or a speaker or the like. The photography device 26 is a camera that takes a still image or video.

### <Functional Block Configuration>

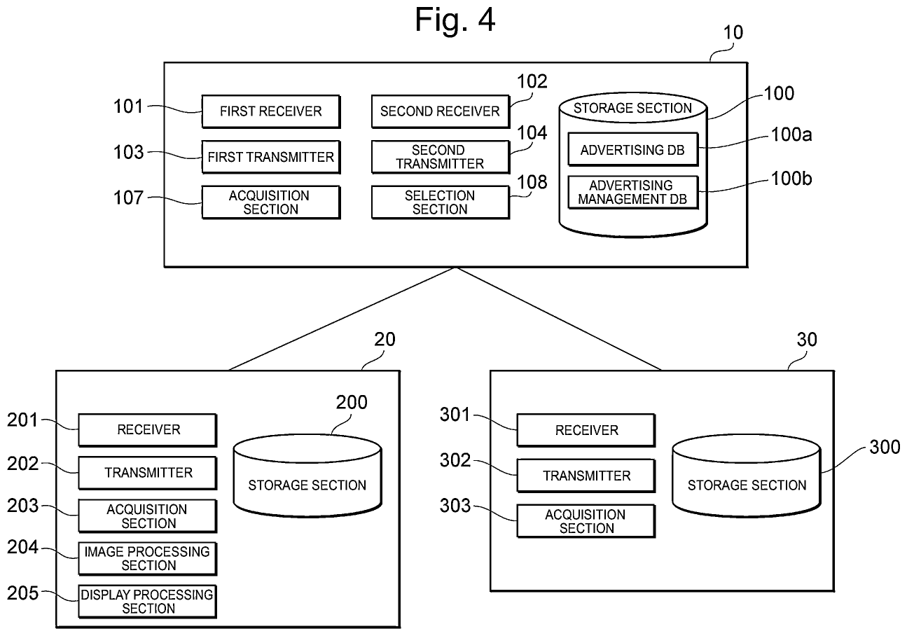

FIG. 4 is a diagram illustrating examples of functional block configurations of the information processing device 10, the digital signage 20, and the POS terminal 30.

### (Information Processing Device)

The information processing device 10 includes a storage section 100, a first receiver 101, a second receiver 102, a first transmitter 103, a second transmitter 104, a determination section 105, an output section 106, an acquisition section 107, and a selection section 108. The first receiver 101 and the second receiver 102 may be collectively referred to as a receiver. The first transmitter 103 and the second transmitter 104 may be collectively referred to as a transmitter. The storage section 100 is able to be implemented using the storage device 12 provided in the information processing device 10. Moreover, the first receiver 101, the second receiver 102, the first transmitter 103, the second transmitter 104, the determination section 105, the output section 106, the acquisition section 107, and the selection section 108 are able to be implemented by the processor 11 of the information processing device 10 executing a program stored in the storage device 12. The program is able to be stored in a storage medium. The storage medium storing the program may be a computer-readable non-transient storage medium. The non-transient storage medium is not particularly limited, but may be a storage medium such as, for example, a universal serial bus (USB) memory or a compact disc read-only memory (CD-ROM).

The storage section 100 stores an advertising database (DB) 100a, which stores data related to advertisements and products corresponding to the advertisements, and an advertising management DB 100b, which manages the advertising effectiveness.

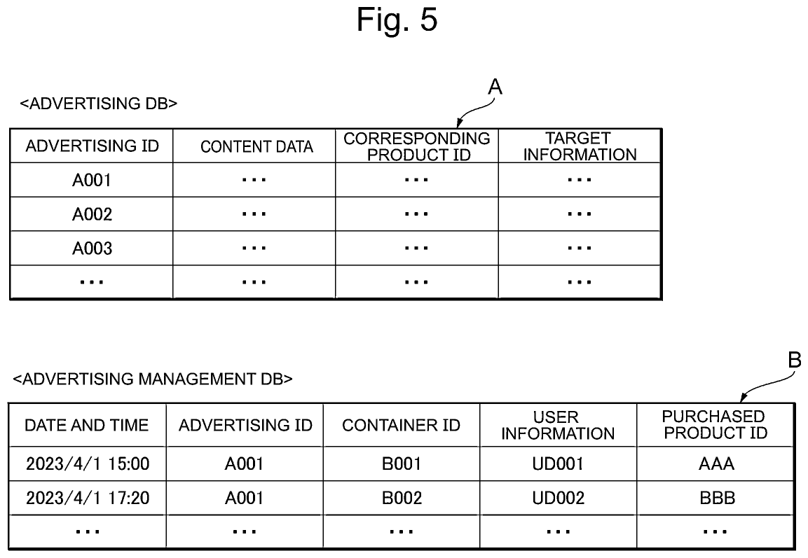

FIG. 5 is a diagram illustrating examples of the advertising DB 100a and the advertising management DB 100b. Reference character A of FIG. 5 illustrates an example of the advertising DB 100a. The term “advertising ID” indicates an identifier that uniquely identifies an advertisement. The term “content data” indicates video or still image data of an advertisement. The term “corresponding product ID” indicates an identifier of the product corresponding to the advertisement. The term “target information” indicates the user attributes of users targeted by the advertisement. For example, “target information” may contain information such as advertisement A001 for males in their 20s and advertisement A003 for females in their 30s. In other words, the advertising DB 100a is a database that manages the correspondence between the advertising ID of an advertisement, the content data of the advertisement, and the product ID of the product corresponding to the advertisement.

B of FIG. 5 illustrates an example of the advertising management DB 100b. The term “date and time” indicates the date and time when the user purchased the product. The term “advertising ID” indicates an identifier that uniquely identifies an advertisement. The term “container ID” indicates the ID of a container used by a user in a store. The term “user information” indicates various information about the user who uses the container, acquired from the digital signage 20. The user information is generated based on the user image of the user who uses the container, which is captured by the digital signage 20. The user information may include, for example, the attributes of the user, and/or information about the image of the user (for example, the image data of the user's face, the user's feature value extracted from the image data, and the like). The term “purchased product ID” indicates an identifier of the product purchased by the user. Note that the “purchased product ID” is set when the user purchased the product corresponding to the advertisement, but not set when the user did not purchase the product corresponding to the advertisement. Returning to FIG. 4, the description is continued.

The first receiver 101 receives various information from the digital signage 20. The first receiver 101 receives the container ID (the first identification information) that identifies the container used by the user, from the digital signage 20.

In addition, the first receiver may further receive, from the digital signage 20, the user information of the user using the container, who is photographed by the digital signage 20. The first receiver may also receive, from the digital signage 20, information about the image of the user using the container, which is captured by the digital signage 20.

The second receiver 102 receives various information from the POS terminal 30. The second receiver 102 also receives, from the POS terminal 30, the container ID (the second identification information) that identifies the container used by the user who purchased the product, and product information about the product purchased by the user.

The first transmitter 103 transmits various information to the digital signage 20. For example, the first transmitter 103 may transmit to the digital signage 20 the advertisement data of the advertisement to be displayed on the display of the digital signage 20.

The second transmitter 104 transmits various information to the POS terminal 30.

The determination section 105 determines that the user using the container has viewed the advertisement and purchased the product concerned when the container ID (the first identification information) received from the digital signage 20 matches the container ID (the second identification information) received from the POS terminal 30 and further the product information received from the POS terminal 30 corresponds to the advertisement displayed on the digital signage 20. The advertisement displayed on the digital signage 20 may be fixed at any time. In that case, the determination section 105 may store in advance which product corresponds to the advertisement displayed on the digital signage 20.

The advertisement displayed on the digital signage 20 may be variable (for example, the advertisement is varied according to the user, the advertisement is varied according to the time of day, or the like). In this case, the first receiver may be configured to receive an advertising ID (advertising identifier) indicating the advertisement displayed on the digital signage 20, in addition to the container ID (the first identification information), from the digital signage 20. Furthermore, the determination section 105 may determine that the user who used the container viewed the advertisement corresponding to the advertising ID and purchased the product, when the product information received from the POS terminal 30 corresponds to the advertisement displayed on the digital signage 20, which is indicated by the advertising ID received from the digital signage 20. The determination section 105 is able to figure out which product corresponds to which advertising ID by referring to the advertising DB 100a. For example, when the advertising ID received from the digital signage 20 is A001 and further the product information, which is received from the POS terminal 30 and indicates the product purchased by the user, matches the product corresponding to the advertising ID (A001), the determination section 105 may determine that the user who used the container purchased the product by viewing the advertisement with the advertising ID (A001). On the other hand, when the advertising ID received from the digital signage 20 is A001 and further the product information, which is received from the POS terminal 30 and indicates the product purchased by the user, does not correspond to the advertising ID (A001), the determination section 105 may determine that the user who used the container viewed the advertisement with the advertising ID (A001) but did not purchase the product corresponding to the advertisement concerned.

Moreover, when determining that the user who used the container purchased the product, the determination section 105 may store the product ID of the product (information about the purchased product) and the user information, so as to be associated with each other, into the advertising management DB 100b (database).

The output section 106 outputs statistical data about the user information of the user who purchased the product, based on the purchased product ID (information about the purchased product) and the user information stored in the advertising management DB 100b.

The acquisition section 107 acquires the identifier used by the user on an EC site on the basis of the information about the user's image included in the user information. For example, it is assumed that the user's feature value previously extracted from the user's face image and a user identifier for the EC site are stored in the EC site with being previously associated with each other. In this case, the acquisition section 107 may transmit the extracted user's feature value to the server of the EC site to inquire the user identifier used in the EC site.

The selection section 108 selects an advertisement to be displayed on the digital signage 20 on the basis of the user information received by the first receiver 101. For example, the selection section 108 may select the advertisement to be displayed on the digital signage 20 by comparing the user attribute included in the user information with the user attribute specified by the “target information” in the advertising DB 100a. Moreover, the selection section 108 instructs the digital signage 20 to display the selected advertisement.

### (Digital Signage)

The digital signage 20 includes a storage section 200, a receiver 201, a transmitter 202, an acquisition section 203, an image processing section 204, and a display processing section 205. The storage section 200 is able to be implemented by using the storage device 22 provided in the digital signage 20. Furthermore, the receiver 201, the transmitter 202, the acquisition section 203, the image processing section 204, and the display processing section 205 are implemented by the processor 21 of the digital signage 20 executing the programs stored in the storage device 22. The programs are allowed to be stored in a storage medium. The storage medium storing the programs may be a computer-readable non-transient storage medium. The non-transient storage medium is not particularly limited, but may be a storage medium such as, for example, a USB memory or a CD-ROM.

The storage section 200 stores various data related to the operation of the digital signage 20. For example, the storage section 200 stores the content data of the advertisement to be displayed on the display. The storage section 200 may store the content data and the advertising ID that are associated with each other.

The receiver 201 receives various data from the information processing device 10. The transmitter 202 transmits various data to the information processing device 10. For example, the transmitter 202 may transmit the container ID of the user who uses the container, the user information, and the advertising ID of the advertisement viewed by the user, to the information processing device 10.

The acquisition section 203 acquires the container ID of the container used by the user present in the vicinity of the digital signage 20. The image processing section 204 generates the user information by analyzing the user's image taken by the photography device 26. The display processing section 205 displays the content of the advertisement on the display.

### (Pos Terminal)

The POS terminal 30 includes the storage section 300, the receiver 301, the transmitter 302, and the acquisition section 303. The storage section 300 is able to be implemented by using the storage device 22 provided in the POS terminal 30. The receiver 301, the transmitter 302, and the acquisition section 303 are able to be implemented by the processor 21 of the POS terminal 30 executing the programs stored in the storage device 22. The programs are able to be stored in a storage medium. The storage medium storing the programs may be a computer-readable non-transient storage medium. The non-transient storage medium is not particularly limited, but may be a storage medium such as, for example, a USB memory or a CD-ROM.

The receiver 301 receives various information from the information processing device 10. The transmitter 302 transmits various information to the information processing device 10. For example, the transmitter 302 transmits the container ID of the user who purchased the product and the product information about the product purchased by the user to the information processing device 10.

The acquisition section 303 acquires the container ID of the container used by the user who purchases the product at the POS terminal 30.

### <Processing Procedure>

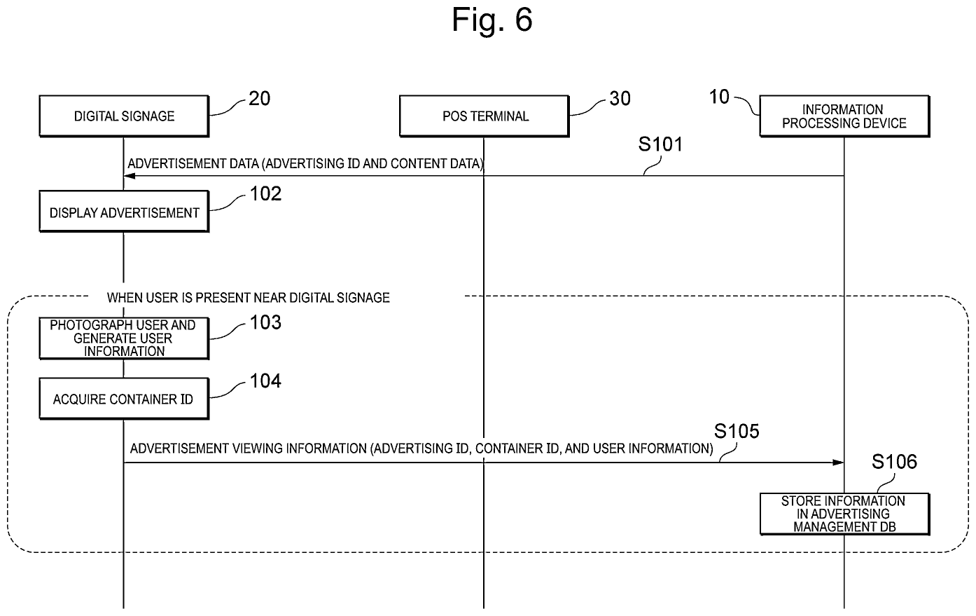

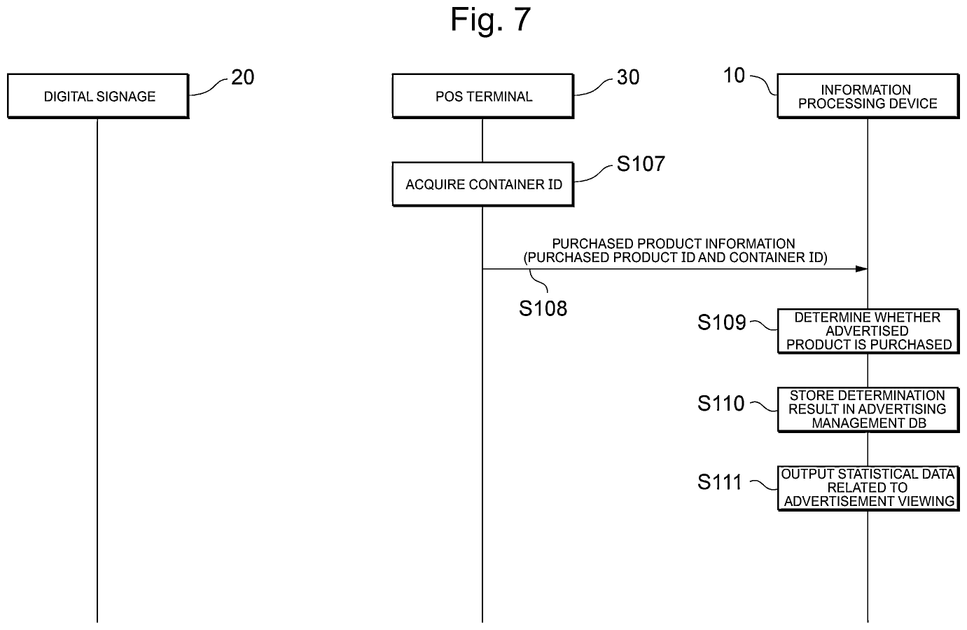

FIGS. 6 and 7 are sequence diagrams illustrating examples of the processing procedures performed by the advertising system 1. The processing procedure from steps S103 to S106 is executed when a user is present in the vicinity of the digital signage 20. The processing procedure from steps S107 to S111 is executed when a user purchases a product.

In step S101, the information processing device 10 acquires advertisement data from the advertising DB 100a and transmits the advertisement data to the digital signage 20. The advertisement data includes the advertising ID and content data of the advertisement to be displayed on the digital signage 20. Note that the processing procedure of step S101 may be performed by a device other than the information processing device 10 (for example, an advertising delivery device), instead of the information processing device 10. Alternatively, the processing procedure of step S101 may be omitted. In this case, the content of the advertisement and the advertising ID may be stored in advance in the digital signage 20.

In step S102, the display processing section 205 of the digital signage 20 causes the display to display the content data received in the processing procedure of step S101.

In the processing procedure of step S101, the advertisement data for a plurality of advertisements may be transmitted to the digital signage 20. The display processing section 205 of the digital signage 20 may display one of the plurality of advertisements on the display and may switch the advertisement to be displayed, on the basis of the attribute or the like of the user present in the vicinity of the digital signage 20 or at predetermined time intervals.

In step S103, the image processing section 204 of the digital signage 20 generates user information from the user image taken by the photography device 26. For example, the image processing section 204 may identify the gender and age of the user from the user image. Moreover, the image processing section 204 may be configured to identify how long the user has been viewing the advertisement by analyzing the user image. The image processing section 204 may also extract the feature value (feature vector) of the user by analyzing the user image.

In step S104, the acquisition section 203 of the digital signage 20 acquires the container ID used by the user present in the vicinity of the digital signage 20.

In step S105, the transmitter 202 of the digital signage 20 transmits advertisement viewing information to the information processing device 10. The advertisement viewing information includes the advertising ID of the advertisement displayed on the digital signage 20, the user information of the user generated by the processing procedure in step S103, and the container ID of the container used by the user. The first receiver 101 of the information processing device 10 receives the advertisement viewing information from the digital signage 20. Note that the user information may include attribute information indicating a user attribute, information on the user's image (image data, user's feature value extracted from the image data, or the like) generated by photographing the user with the digital signage 20, the time when the user was photographed with the camera (the time at which the user is determined to have viewed the advertisement), and/or the length of time during which the user was photographed with the camera (the length of time during which the user is determined to have been viewing the advertisement such as, for example, 5 or 20 seconds). Moreover, the attribute information may include, for example, the gender and age of the user. The user image may be an image of the user's face.

In step S106, the first receiver 101 of the information processing device 10 stores the advertising ID, the container ID, and the user information included in the advertisement viewing information received in the processing procedure of step S105 in the advertising management DB 100b with being associated with the date and time when the advertisement viewing information is received.

In step S107, the acquisition section 303 of the POS terminal 30 acquires the container ID of the container used by the user when the user purchases a product.

In step S108, the transmitter 302 of the POS terminal 30 transmits the purchased product information to the information processing device 10. The purchased product information includes the product ID of the product purchased by the user and the container ID acquired by the processing procedure in step S107.

In step S109, the determination section 105 of the information processing device 10 searches the advertising management DB 100b to determine whether there is a record that contains the same “container ID” as the “container ID” received from the POS terminal 30 in the processing procedure of step S108. Note that, considering that the same container is used repeatedly, the determination section 105 may search for the “container ID” for records for which the “date and time” is within a predetermined period of time from the time when the purchased product information is received from the POS terminal 30. In the case where there is no record that contains the same “container ID” as the “container ID” received from the POS terminal 30, the information processing device 10 terminates the process.

On the other hand, in the case where there is a record that contains the same “container ID” as the “container ID” received from the POS terminal 30, the determination section 105 acquires the advertising ID corresponding to the purchased product ID received in the processing procedure of step S108 from the advertising DB 100a, and then determines whether the acquired advertising ID matches the advertising ID in the record concerned. In the case where the acquired advertising ID does not match the advertising ID in the record concerned, the information processing device 10 terminates the process. On the other hand, in the case where the acquired advertising ID matches the advertising ID in the record concerned, the information processing device 10 determines that the user who used the container has viewed the advertisement and purchased the product, and the control proceeds to the processing procedure of step S110.

In step S110, the determination section 105 of the information processing device 10 stores the purchased product ID received in the processing procedure of step S108 into the record containing the same “container ID” as the “container ID” received from the POS terminal 30 and detected in the processing procedure of step S109.

In step S111, the output section 106 of the information processing device 10 accesses the advertising management DB 100b to generate and output statistical data about advertisement viewing. Note that the processing procedure of step S111 may be performed at an arbitrary timing, for example, as directed by an advertising manager or others, instead of being performed after the processing procedure of step S110.

For example, the statistical data may include data indicating the number of users who purchased the product for each advertising ID in the past predetermined period. The statistical data may also include data indicating the percentage of users who purchased the product out of the users who were determined to have viewed the advertisement (more specifically, the users using the container detected by the digital signage 20). The data may be calculated, for example, by dividing the number of records with their “purchased product IDs” stored, among the plurality of records with the same advertising ID contained in the advertising management DB, by the number of the plurality of records with the same advertising ID.

The statistical data may include data indicating the relationship between the length of time during which a user is determined to have viewed the advertisement and the percentage of users who actually purchased the product. For example, the statistical data may include data indicating the product purchase ratio of users who viewed the advertisement for 1 to 10 seconds and the product purchase ratio of users who viewed the advertisement for 11 seconds or longer.

### <Variation>

When the advertisement displayed on the digital signage 20 is a video, the digital signage 20 may transmit data, indicating for what period of time and how many times the advertisement was played, to the information processing device 10. For example, there may be transmitted data indicating that the video advertisement whose advertising ID is A001 was played 200 times in two hours from 8:00 to 10:00. The statistical data may also include data indicating the relationship between the number of times the advertisement is played and the percentage of users who actually purchased the product.

The acquisition section 107 of the information processing device 10 may acquire the user ID used in the EC site, on the basis of the information about the user's image (for example, the user's face image data) included in the user information received in the processing procedure of step S105. For example, it is assumed that a user's feature value previously extracted from the user's face image and a user ID for the EC site are stored at the EC site in advance with being associated with each other. In this case, the acquisition section 107 may inquire the user ID used in the EC site by transmitting the user's feature value to the server of the EC site. In addition, the acquisition section 107 may also acquire the advertisement displayed on the user's EC site associated with the user ID, information on the product that the user has viewed on the EC site, information on the user's attribute, and/or information on the purchase history or the like on the user's EC site, from the server of the EC site. This enables the information processing device 10 to utilize various information such as the advertisement displayed on the EC site of the user who is determined to have viewed the advertisement, the product viewed by the user at the EC site, the attribute of the user, and the purchase history of the user, and thereby to recommend products based on various information obtained from the EC site and to select an advertisement to be displayed on the digital signage 20.

In the processing procedure in FIG. 6, the advertisement displayed on the digital signage 20 may be varied based on the attribute information of the user present in the vicinity of the digital signage 20. In this case, it is assumed that the processing procedures in steps S101 and S102 are omitted and that the advertisement viewing information transmitted in step S105 does not include “advertising ID.” First, the selection section 108 of the information processing device 10 selects an advertisement to be displayed on the digital signage 20 on the basis of the user information received in the processing procedure of step S105. For example, the selection section 108 may select an advertisement to be displayed on the digital signage 20 by comparing the user attribute included in the user information with the user attribute specified in the “target information” of the advertising DB 100b. Subsequently, the selection section 108 of the information processing device 10 transmits the content data and advertising ID of the selected advertisement to the digital signage 20 via the first transmitter 103. In addition, in the processing procedure of step S106, the first receiver 101 of the information processing device 10 stores the container ID and user information included in the advertisement viewing information received in the processing procedure of step S105 and the advertising ID transmitted to the digital signage 20 in the advertising management DB 100b, with being associated with the date and time when the advertisement viewing information is received.

In the processing procedure of step S105, the first receiver may be configured to receive, from the digital signage 20, the container ID of the container used by the user and the face image of the user who uses the container, which were taken by the digital signage 20. In the processing procedure of step S109, the determination section 105 may receive the container ID and the user's face image from the digital signage 20 and then determine that the “user who viewed the advertisement” has purchased the product corresponding to the advertisement when the container ID received from the digital signage 20 matches the container ID received from the POS terminal 30 and further the product information received from the POS terminal 30 corresponds to the advertisement displayed on the digital signage 20. This is because the user is presumed to have viewed the advertisement displayed on the digital signage 20 when the user's face is photographed on the digital signage 20.

### <Conclusion>

According to the embodiments described above, the advertising system 1 uses a container ID to detect that the user who uses a container has actually purchased a product after viewing an advertisement. This makes it possible to provide a technique that enables more accurate measurement of the advertising effectiveness.

The embodiments described above are intended to facilitate understanding of the present disclosure and are not intended to be interpreted as limiting the scope of the present disclosure. The flowchart and sequence described in the embodiments, the elements of the embodiments and their arrangement, materials, conditions, shapes, and sizes are not limited to those shown in the examples, and may be changed as necessary. It is also possible to partially replace or combine the configurations illustrated in the different embodiments.

### <Addendum>

### <Addendum 1>

An information processing device comprising:
a first receiver that receives first identification information for identifying a container used by a user, from a display device that displays an advertisement about a product;
a second receiver that receives, from a terminal, second identification information for identifying the container used by the user who purchased the product and product information about the product; and
a determination section that determines that the user who used the container purchased the product after viewing the advertisement, when the first identification information received from the display device matches the second identification information received from the terminal and further the product information received from the terminal corresponds to the advertisement displayed on the display device.

### <Addendum 2>

The information processing device according to Addendum 1, wherein:
the first receiver further receives, from the display device, the user information of the user using the container, who is photographed by the display device; and
the determination section store information on the purchased product and the user information into a database, with being associated with each other, when determining that the user using the container has purchased the product.

### <Addendum 3>

The information processing device according to Addendum 2, further comprising an output section that outputs statistical data on the user information of the user who purchased the product, based on the information on the product and the user information stored in the database.

### <Addendum 4>

The information processing device according to any one of Addendums 1 to 3, wherein:
the first receiver receives, from the display device, information about the image of the user using the container, the image being taken by the display device; and
the information processing device includes an acquisition section that acquires an identifier used by the user on an EC site, based on the information about the user's image.

### <Addendum 5>

The information processing device according to any one of Addendums 1 to 4, wherein:
the first receiver receives, from the display device, the user information of the user using the container, taken by the display device; and
the information processing device includes a selection section that selects an advertisement to be displayed on the display device based on the user information and instructs the display device to display the advertisement.

### <Addendum 6>

The information processing device according to any one of Addendums 1 to 5, wherein:
the first receiver receives the image of the face of the user using the container, taken by the display device, in addition to the first identification information; and
the determination section receives the user's face image from the display device and determines that the user who viewed the advertisement purchased the product when the first identification information received from the display device matches the second identification information received from the terminal and further the product information received from the terminal corresponds to the advertisement displayed on the display device.

### <Addendum 7>

The information processing device according to any one of Addendums 1 to 6, wherein:
the first receiver receives an advertisement identifier indicating the advertisement displayed on the display device, in addition to the first identification information; and
the determination section determines that the user using the container has viewed the advertisement corresponding to the advertisement identifier and purchased the product, when the product information received from the terminal corresponds to the advertisement displayed on the display device indicated by the advertisement identifier.

### <Addendum 8>

An information processing method comprising the steps of:
receiving, from a display device that displays an advertisement about a product, first identification information for identifying a container used by a user who viewed the advertisement displayed on the display device;
receiving, from a terminal, second identification information for identifying the container used by the user who purchased the product and product information about the product; and
determining that the user who used the container purchased the product after viewing the advertisement, when the first identification information received from the display device matches the second identification information received from the terminal and further the product information received from the terminal corresponds to the advertisement displayed on the display device.

### <Addendum 9>

A program for causing a computer to perform the steps of:
receiving, from a display device that displays an advertisement about a product, first identification information for identifying a container used by a user who viewed the advertisement displayed on the display device;
receiving, from a terminal, second identification information for identifying the container used by the user who purchased the product and product information about the product; and
determining that the user who used the container purchased the product after viewing the advertisement, when the first identification information received from the display device matches the second identification information received from the terminal and further the product information received from the terminal corresponds to the advertisement displayed on the display device.

### DESCRIPTION OF THE REFERENCE NUMERALS

1: advertising system
10: information processing device
11: processor
12: storage device
13: communication device
14: input device
15: output device
20: digital signage
21: processor
22: memory device
23: communication device
24: input device
25: output device
26: photography device
30: POS terminal
100: storage section
100a: advertising DB
100b: advertising management DB
101: first receiver
102: second receiver
103: first transmitter
104: second transmitter
105: determination section
106: output section
107: acquisition section
108: selection section
200: storage section
201: receiver
202: transmitter
203: acquisition section
204: image processing section
205: display processing section
300: storage section
301: receiver
302: transmitter
303: acquisition section

What is claimed is:

1. An information processing device comprising:
a first receiver that receives first identification information for identifying a container used by a user, from a display device that displays an advertisement about a product;
a second receiver that receives, from a terminal, second identification information for identifying a container used by a user who purchased a product and product information about the product; and
a determination section that determines that the user who used the container purchased the product after viewing the advertisement, when the first identification information received from the display device matches the second identification information received from the terminal and further the product information received from the terminal corresponds to the advertisement displayed on the display device.

2. The information processing device according to claim 1, wherein:
the first receiver further receives, from the display device, the user information of the user using the container, who is photographed by the display device; and
the determination section store information on the purchased product and the user information into a database, with being associated with each other, when determining that the user using the container has purchased the product.

3. The information processing device according to claim 2, further comprising an output section that outputs statistical data on the user information of the user who purchased the product, based on the information on the product and the user information stored in the database.

4. The information processing device according to claim 1, wherein:
the first receiver receives, from the display device, information about the image of the user using the container, the image being taken by the display device; and
the information processing device includes an acquisition section that acquires an identifier used by the user on an EC site based on the information about the user's image.

5. The information processing device according to claim 1, wherein:
the first receiver receives, from the display device, the user information of the user using the container, taken by the display device; and
the information processing device includes a selection section that selects an advertisement to be displayed on the display device based on the user information and instructs the display device to display the advertisement.

6. The information processing device according to claim 1, wherein:
the first receiver receives the image of the face of the user using the container, taken by the display device, in addition to the first identification information; and
the determination section receives the user's face image from the display device and determines that the user who viewed the advertisement purchased the product when the first identification information received from the display device matches the second identification information received from the terminal and further the product information received from the terminal corresponds to the advertisement displayed on the display device.

7. The information processing device according to claim 1, wherein:
the first receiver receives an advertisement identifier indicating the advertisement displayed on the display device, in addition to the first identification information; and
the determination section determines that the user using the container has viewed the advertisement corresponding to the advertisement identifier and purchased the product, when the product information received from the terminal corresponds to the advertisement displayed on the display device indicated by the advertisement identifier.

8. An information processing method comprising the steps of:
receiving, from a display device that displays an advertisement about a product, first identification information for identifying a container used by a user who viewed the advertisement displayed on the display device;
receiving, from a terminal, second identification information for identifying a container used by a user who purchased a product and product information about the product; and
determining that the user who used the container purchased the product after viewing the advertisement, when the first identification information received from the display device matches the second identification information received from the terminal and further the product information received from the terminal corresponds to the advertisement displayed on the display device.

9. A computer-readable non-transitory storage medium storing a program for causing a computer to perform the steps of:
receiving, from a display device that displays an advertisement about a product, first identification information for identifying a container used by a user who viewed the advertisement displayed on the display device;
receiving, from a terminal, second identification information for identifying a container used by a user who purchased a product and product information about the product; and
determining that the user who used the container purchased the product after viewing the advertisement, when the first identification information received from the display device matches the second identification information received from the terminal and further the product information received from the terminal corresponds to the advertisement displayed on the display device.
